(19) United States
(12) Patent Application Publication
(10) Pub. No.: US 2008/0201661 A1
(43) Pub. Date: Aug. 21, 2008

(54) Remote flash storage management

(75) Inventors: Simon Haynes, Send (GB); Jalal Sadr, Irvine, CA (US)

Correspondence Address: STEC, Inc.;c/o Legal Department, 3001 Daimler Street, Santa Ana, CA, 92705-5812, US

(73) Assignee: STEC, Inc., Santa Ana, CA (US)

(21) Appl. No.: 12/012,773

(22) Filed: Feb. 4, 2008

Related U.S. Application Data
(60) Provisional application No. 60/899,452, filed on Feb. 3, 2007.

(51) Int. Cl. G06F 17/30; G06F 3/048

(52) U.S. Cl. 715/810; 707/100; 707/E17.044

(57) ABSTRACT

A computing host executes a web browser to access a utility application for managing or altering one or more storage devices connected to the computing host. Management or alteration of each storage device may include various purging of the storage device, encrypting the storage device, password protecting the storage device, purging the data or the firmware of the storage device, updating firmware of the storage device, updating programmable hardware of the storage device, erasing the storage device, sanitizing the storage device, logging events occurring in the storage device, and maintaining statistics on operation of the storage device.

### CROSS-REFERENCE TO RELATED APPLICATIONS

The present invention claims benefit of U.S. provisional patent application No. 60/899,452 filed Feb. 3, 2007 and entitled “Remote Flash Disk Management,” which is incorporated herein by reference; the subject matter of the present application is related to the following co-pending U.S. patent applications: U.S. patent application filed Feb. 4, 2008 and entitled “DATA STORAGE DEVICE MANAGEMENT SYSTEM AND METHOD”, and U.S. patent application filed Feb. 4, 2008 and entitled “IMPROVED FLASH FIRMWARE MANAGEMENT”, wherein all of the foregoing are herein incorporated by reference in their entirety.

### BACKGROUND

1. Field of Invention

The present invention generally relates to data storage devices, and more particularly to management of data storage devices.

2. Description of Related Art

A computing system typically includes a data storage device for storing data. In some types of computing systems, the data storage device includes data and a programmable controller for controlling functionality of the data storage device. In these types of computing systems, it may be desirable to remotely alter the data storage device. Generally, any such alteration may require physical access to the storage device and thus, may be time consuming and result in considerable downtime of the computing system.

In light of the above, a need exists for an improved system and method of altering a data storage device. A further need exists for efficiently managing or altering a data storage device.

### SUMMARY

In various embodiments, a utility application communicates with a computing host via a communication network to manage a storage device connected to the computing host. Management of the storage device includes updating functionality of the storage device during operation of the computing host by modifying firmware in the storage device or by modifying programmable hardware in the storage device. In this way, the computing host need not be powered down to update the functionality of the storage device. In further embodiments, the utility application manages the storage device by erasing the storage device, sanitizing the storage device, logging events occurring in the storage device, and maintaining statistics on operation of the storage device.

A method of managing a storage device, in accordance with one embodiment, includes generating a web page indicating at least one storage device and selecting a storage device of the at least one storage device. The method further includes generating a web page indicating at least one function and selecting a function of the at least one function. The method also includes performing the selected function on the selected storage device.

A method of managing a storage device, in accordance with one embodiment, includes generating a web page indicating at least one storage device, displaying the web page indicating the at least one storage device by user a web browser, and selecting a storage device of the at least one storage device by using the web browser. The method further includes generating a web page indicating at least one function, displaying the web page indicating the at least one function by using the web browser, and selecting a function of the at least one function by using the web browser. The method also includes performing the selected function on the selected storage device.

A system of managing a storage device, in accordance with one embodiment, includes a means for generating a web page indicating at least one storage device and a means for selecting a storage device of the at least one storage device. The system further comprises a means for generating a web page indicating at least one function and a means for selecting a function of the at least one function. Additionally, the system comprises a means for performing the selected function on the selected storage device.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a block diagram of a computing environment including a computing host, a server, a communication network, and storage devices, in accordance with an embodiment of the present invention.

FIG. 2 is a block diagram of a storage device, in accordance with an embodiment of the present invention.

FIG. 3 is a block diagram of a storage device, in accordance with an embodiment of the present invention.

FIG. 4 is a block diagram of a storage controller, in accordance with an embodiment of the present invention.

FIG. 5 is a block diagram of a user interface, in accordance with an embodiment of the present invention.

FIG. 6 is a flow chart for a method of managing a storage device, in accordance with the present invention.

FIG. 7 is a flow chart for a portion of the method of managing the storage device, in accordance with an embodiment of the present invention.

FIG. 8 is a flow chart for a portion of the method of managing the storage device, in accordance with an embodiment of the present invention.

FIG. 9 is a flow chart for a portion of the method of managing the storage device, in accordance with an embodiment of the present invention.

FIG. 10 is a flow chart for a portion of the method of managing the storage device, in accordance with an embodiment of the present invention.

FIG. 11 is a flow chart for a portion of the method of managing the storage device, in accordance with an embodiment of the present invention.

FIG. 12 is a flow chart for a portion of the method of managing the storage device, in accordance with an embodiment of the present invention.

FIG. 13 is a screen shot of an exemplary web page, in accordance with an embodiment of the present invention.

FIG. 14 is a screen shot of an exemplary web page, in accordance with an embodiment of the present invention.

FIG. 15 is a screen shot of an exemplary web page, in accordance with an embodiment of the present invention.

FIG. 16 is a screen shot of an exemplary web page, in accordance with an embodiment of the present invention.

FIG. 17 is a screen shot of an exemplary web page, in accordance with an embodiment of the present invention.

FIG. 18 is a screen shot of an exemplary web page, in accordance with an embodiment of the present invention.

FIG. 19 is a screen shot of an exemplary web page, in accordance with an embodiment of the present invention.

FIG. 20 is a screen shot of an exemplary web page, in accordance with an embodiment of the present invention.

FIG. 21 is a screen shot of an exemplary web page, in accordance with an embodiment of the present invention.

FIG. 22 is a screen shot of an exemplary web page, in accordance with an embodiment of the present invention.

### DESCRIPTION

In various embodiments, a computing host communicates with a utility application via a communication network for managing a storage device connected to the computing host. Management of the storage device includes updating functionality of the storage device during operation of the computing host.

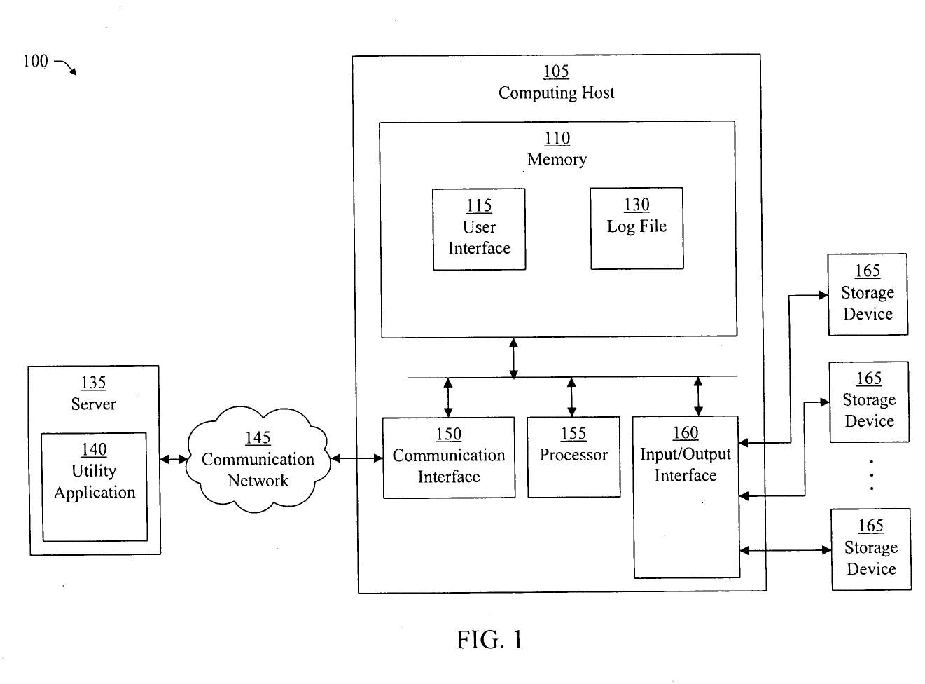

FIG. 1 illustrates a computing environment 100 including a computing host 105, a server 135, a communication network 145, and storage devices 165, in accordance with an embodiment of the present invention. The communication network 145 is coupled to the computing host 105 and the server 135. Further, the storage devices 165 are coupled to the computing host 105. The computing host 105 may be any type computing or electronic device, such as a computer workstation, a portable computer, an embedded computing system, a network router, a portable computer, a personal digital assistant, a digital camera, a digital phone, or the like. The server 135 may be any type of computing system, such as a computer workstation, a computer server, or the like. The communication network 145 may be any type of network for facilitating communication between the server 135 and the computing host 105, such as the Internet, a local area network, a wide area network, an Ethernet network, a wireless network, or the like. The storage device 165 may be any type of device for storing data, such as a disk drive, a solid-state drive, a flash storage device, a flash memory card, a secure digital (SD) card, a memory stick, a CompactFlash card, or the like. Although three storage devices 165 are illustrated in FIG. 1, more or fewer than three storage devices 165 may be coupled to the computing host 105 in other embodiments.

The computing host 105 includes a memory 110, a communication interface 150, a processor 155, and an input/output interface 160, which are coupled in communication with each other. Additionally, the communication interface 150 is coupled to the communication network 145, and the input/output interface 160 is coupled to the storage devices 165. As illustrated in FIG. 1, the memory 110 contains a user interface 115 for managing the storage device 165 and a log file 130. The user interface 115 may include any software, firmware, or hardware for displaying data and receiving input from a user of the computing host 105. For example, the user interface 115 may be a graphical user interface, such as a web browser. The log file 130 include message logs and statistics logs generated during management of the storage devices 165, as is described more fully herein. The server 135 includes a utility application 140 for managing the storage devices 165 in conjunction with the user interface 115. In various embodiments, the server 135 executes the utility application 140 while the computing host 105 executes the user interface 115. Moreover, the utility application 140 communicates with the user interface 115 via the communication network 145 and the communication interface 150. In some embodiments the server 135 and the communication network 145 are optional. In these embodiments, the computing host 105 contains the utility application 140, for example by storing the utility application 140 in the memory 110.

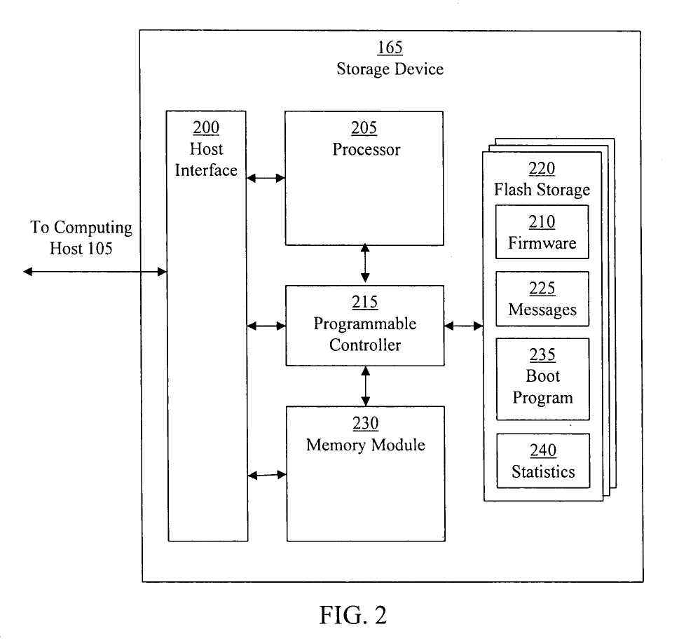

FIG. 2 illustrates the storage device 165, in accordance with an embodiment of the present invention. The storage device 165 includes a host interface 200, a processor 205, a programmable controller 215, and one or more flash storage 220, and a memory module 230. The host interface 200 is coupled to the computing host 105, the processor 205, the programmable controller 215, and the memory module 230. Additionally, the programmable controller 215 is coupled to the processor 205, the flash storage 220, and the memory module 230. The host interface 200 may include any device or protocol for facilitating communication between the computing host 105 and the storage device 165. The processor 205 may be any type of device for executing firmware 210 to control operations in the storage device 165. For example, the processor 205 may be a microprocessor, an embedded processor, a microcontroller, or the like. The firmware 210 may be any computing code executable by the processor 205. In various embodiments, the flash storage 220 stores the firmware 210 and the processor 205 or the programmable controller 215, or both, load the firmware 210 from the flash storage 220 to the memory module 230. For example, the processor 205 or the programmable controller 215, or both, may load the firmware 210 from the flash storage 220 to a DRAM of the memory module 230. Further, the processor 205 accesses the firmware 210 from the memory module 230 and executes the firmware 210. In one embodiment, the processor 205 is a programmable 8051 microcontroller. In this embodiment, the processor 205 includes the firmware 210 and the functionality of the processor 205 is programmable by modifying the firmware 210. In other embodiments, the firmware 210 may be external of the processor 205 but accessible to the processor 205.

The programmable controller 215 controls operations performed on the flash storage 220 and the memory module 230. For example, the programmable controller 215 may perform read, write, or erasure operations on the flash storage 220. As another example, the programmable controller 215 may perform read or write operations on the memory module 230. The programmable controller 215 may include any hardware, software, or both, which is programmable. In various embodiments, the programmable controller 215 includes one or more field programmable gate arrays (FPGAs) and may include one or more memory devices for storing a hardware configuration (e.g., a hardware version) of the programmable controller 215.

The flash storage 220 may be any type of non-volatile storage, such as NAND-type flash storage, NOR-type flash storage, or the like. Although three instances of the flash storage 220 are illustrated in FIG. 2, the storage device 165 may have more or fewer than three instances of flash storage 220 in other embodiments. The memory module 230 may include any type of memory, such as such as a random access memory (RAM), a dynamic random access memory (DRAM), a static random access memory (SRAM), a synchronous dynamic random access memory (SDRAM), a flash storage, an electrically erasable read-only memory (EEROM), an erasable programmable read-only memory EPROM, an electrically erasable programmable read-only memory (EEPROM), or the like, or any combination thereof.

As illustrated in FIG. 2, the flash storage 220 contains the firmware 210, messages 225, a boot program 235, and statistics 240. The messages 225 indicate events that have occurred in the storage device 165. The flash storage device 165 generates the messages 225 and stores the messages 225 in the flash storage 220 for later retrieval, as is described more fully herein. For example, the messages 225 may indicate an error that has occurred in the storage device 165. In other embodiments, the storage device 165 may store the messages 225 in another component of the storage device 165, such as the memory module 230. In various embodiments, the storage device 165 transfers the messages 225 between the flash storage 220 and the memory module 230 during operation of the storage device 165. For example, the processor 205 or the programmable controller 215, or both, may load the messages 225 from the flash storage 220 into a DRAM of the memory module 230 at power up or reset of the storage device 165 and write the messages 225 from the DRAM of the memory module 230 to the flash storage 220 at power down of the storage device 165.

The storage device 165 executes the boot program 235 to initialize the storage device 165, for example on power up of the storage device 165. For example, the boot program 235 may be a basic input output system (BIOS), an application level program, an operating system, or the like. In various embodiments, the processor 205 or the programmable controller 215, or both, execute the boot program 235. In various embodiments, the storage device 165 loads the boot program 235 from the flash storage 220 to the memory module 230. For example, the processor 205 or the programmable controller 215, or both, may load the boot program 235 from the flash storage 220 to an EPROM of the memory module 230 at power up or reset of the flash storage device 165. The processor 205 may then access the boot program 235 from the EPROM and execute the boot program 235.

The storage device 165 generates the statistics 240 during operation of the storage device 165. For example, the statistics 240 may include counts of the number of read operation or write operations performed in the storage device 165 since power up of the storage device 165. In various embodiments, the processor 205 or the programmable controller 215, or both, generate the statistics 240. In various embodiments, the storage device 165 transfers the statistics 240 between the flash storage 220 and the memory module 230 during operation of the storage device 165. For example, the processor 205 or the programmable controller 215, or both, may load the statistics 240 from the flash storage 220 into a DRAM of the memory module 230 at power up or reset of the storage device 165 and write the statistics 240 from the DRAM of the memory module 230 to the flash storage 220 at power down of the storage device 165.

In operation, the utility application 140 performs various functions on the storage devices 165. Additionally, the utility application 140 determines storage devices 165 that are available (e.g., coupled to the computing host 105) and provides a communication to the user interface 115 indicating the available storage devices 165. In turn, the user interface 115 displays the available storage device 165. The user then identifies one of the storage devices 165 via the user interface 115 and the user interface 115 communicates the identified storage device 165 to the utility application. The utility application 140 selects the identified storage device 165 based on the communication received from the user interface 115 and provides a communication to the user interface 115 indicating available functions for the selected storage device 165. In turn, the user interface 115 displays the available functions. In one embodiment, the available functions include a firmware update function, a hardware update function, an erasure function, a sanitizing function, a message function, a statistics function. The user identifies a function by providing an input to the user interface 115 and the user interface 115 provides a communication to the utility application 140 indicating the identified function. The utility application 140 selects the identified function based on the communication received from the user interface 115 and performs the selected function on the selected storage device 165.

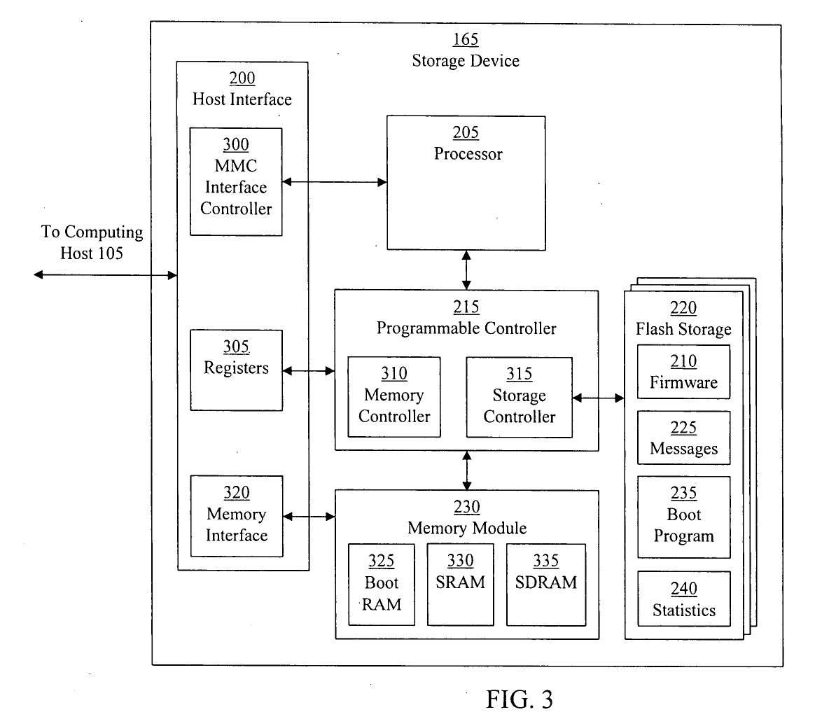

FIG. 3 illustrates the storage device 165, in accordance with an embodiment of the present invention. In this embodiment, the host interface 200 includes a multimedia card (MMC) interface 300, registers 305, and a memory interface 320. The MMC interface 300 is coupled to the processor 205 and facilitates communication between the computing host 105 and the processor 205. The registers 305 are coupled to the programmable controller 215 and facilitate communication between the computing host 105 and the programmable controller 215. For example, both the computing host 105 and the programmable controller 215 may exchange data by reading and writing the data to the registers 305. The memory interface 320 is coupled to the memory module 230 and facilitates communication between the computing host 105 and the memory module 230.

The programmable controller 215 includes a memory controller 310 and a storage controller 315. The memory controller 310 controls memory operations between the processor 205 and the memory module 230. The storage controller 315 controls storage operations performed on the flash storage 220. In various embodiments, the memory controller 310 or the storage controller 315, or both, are programmable by programming the programmable controller 215, as is described more fully herein.

The memory module 230 includes a boot random-access memory (boot RAM) 325, a static random access memory (SRAM) 330, and a static-dynamic random-access memory (SDRAM) 335. The boot RAM 325 is preferably a non-volatile memory or storage, such as read-only memory (ROM), an EEROM, an EPROM, an EEPROM, a flash storage, or the like. In other embodiments, the memory module 230 may include more or fewer types of memory. In various embodiments, the storage device 165 loads the boot program 235 from the flash storage 220 to the boot RAM 325 on power up or reset of the storage device 165. Further, the storage device 165 loads the messages 225 and the statistics 240 from the flash storage 220 to the SDRAM 335 at power up or reset of the storage device 165 and writes the messages 225 and the statistics 240 from the SDRAM 335 to the flash storage 220 at power down of the storage device 165.

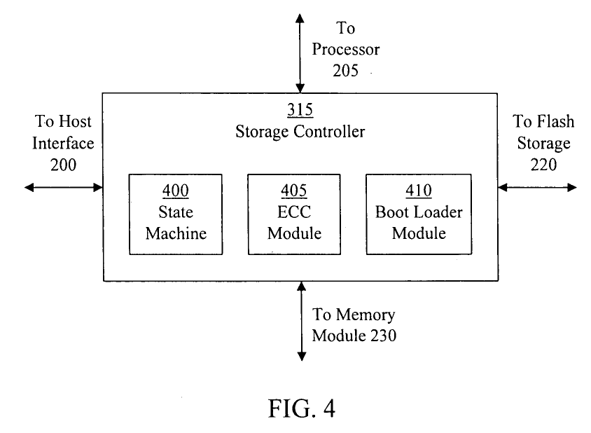

FIG. 4 illustrates the storage controller 315, in accordance with an embodiment of the present invention. The storage controller 315 includes a state machine 400, an error correction code (ECC) module 405, and a boot loader module 410. The state machine 400 controls operation of the storage controller 315, including operation of the ECC module 405 and the boot loader module 410. The ECC module 405 performs error detection and correction on data stored in the flash storage 220. For example, the ECC module 405 may generate an error correction code for data to be written into the flash storage 220 and write the error correction code to the flash storage 220 along with the ECC. Further, the ECC module 405 may read the error correction code from the flash storage 220 along with the data and perform error detection and correction on the data as is appropriate. The boot loader module 410 loads the boot program 235 from the flash storage 200 to the memory module 230, for example on power up of the storage device 165, and the programmable controller 215 or the processor 205, or both, execute the boot program 235 to initialize the storage device 165.

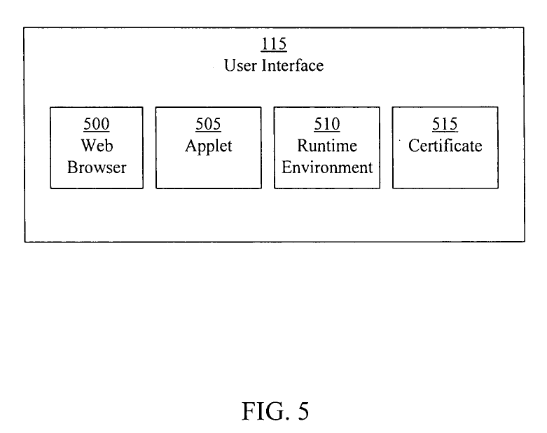

FIG. 5 illustrates the user interface 115, in accordance with an embodiment of the present invention. The user interface 115 includes a web browser 500, an applet 505, a runtime environment 510, and a certificate 515. The web browser 500 may be any type of web browser, such as Internet Explorer, Firefox, Opera, or the like. The applet 505 may be any type of computing code that executes in the web browser 500. For example, the applet 505 may be a Java applet. The runtime environment 510 may be any type of software, firmware, hardware, or in combination thereof, for facilitating execution of the applet 505. For example, the runtime environment 510 may be a Java runtime environment. The certificate 515 may be any type of authentication certificate, such as a certificate issued by a certificate issuing authority.

In various embodiments, the web browser 500 operates in conjunction with the utility application 140, the applet 505, and the runtime environment 510 to perform functions on the storage devices 165. For example, the applet 505 may facilitate communication between the utility application 140 and the computing host 105, such as providing commands generated by the utility application 140 to the computing host 105. In some embodiments, the applet 505 is part of the utility application 140. For example, the utility application 140 may provide the applet 505 to the web browser 500 via the communication network 145 in response to a request from the web browser 500.

In some embodiments, the web browser 500 obtains the certificate 125 from the utility application 140 before the utility application 140 performs functions on the storage devices 165. In this process, the utility application 140 generates a web page and the web browser 500 displays the web page. Further, a user selects an appropriate button on the web page to request the certificate 125. In turn, the web browser 500 sends a request for the certificate 125 to the utility application 140 through the communication network 145. In response to the request, the utility application 140 sends the certificate 125 to the web browser 500. The user may then select an appropriate button on the web page to indicate whether the certificate 125 is accepted or rejected. In turn, the web browser 500 accepts or rejects the certificate 125 based on the selected button. If the web browser 500 accepts the certificate 125, the utility application 140 is enabled to perform functions on the storage devices 165 through the web browser 500.

In one embodiment, the utility application 140 performs a firmware update function on a storage device 165. In this embodiment, the utility application 140 determines whether any firmware versions are available for any of the storage device 165. Further, the utility application 140 generates a web page indicating any available firmware versions and the web browser 500 displays the web page. A user then provides input identifying a firmware version to the web browser 500. For example, the user may select a button on the web page to identify the firmware version. The web browser 500 provides a communication to the utility application 140 indicating the identified firmware version and the utility application 140 selects the identified firmware version based on the communication. Further, the utility application 140 downloads the selected firmware version to the computing host 105 and programs the storage device 165 with the selected firmware version to update the firmware 210 in the processor 205.

In some embodiments, the utility application 140 disables the computing host 105 from performing other input/output operations on the storage device 165 during the firmware update function. In one embodiment, if a power failure occurs when the utility application 140 is programming the storage device 165 with the selected firmware version, the utility application 140 detects the power failure and performs the firmware update function a second time after power has been restored to the storage device 165.

In one embodiment, the utility application 140 performs a hardware update function on a storage device 165. In this embodiment, the utility application 140 determines whether any hardware version (e.g., hardware configurations of the programmable controller 215) is available for any of the storage devices 165. Further, the utility application 140 generates a web page indicating any available hardware version and the web browser 500 displays the web page. A user then provides input identifying a hardware version to the web browser 500. For example, the user may select a button on the web page to identify the hardware version. The web browser 500 provides a communication to the utility application 140 identifying the hardware version and the utility application 140 selects the identified hardware version based on the communication. Further, the utility application 140 downloads the selected hardware version to the computing host 105 and programs the storage device 165 with the selected hardware version to update the programmable controller 215.

In some embodiment, the utility application 140 disables the computing host 105 from performing other input/output operations on the selected storage device 165 during the hardware update function. In one embodiment, if a power failure occurs when the utility application 140 is programming the storage device 165 with the selected hardware version, the utility application 140 detects the power failure and performs the hardware update function a second time after power has been restored to the selected storage device 165.

In one embodiment, the utility application 140 performs an erasure function on a storage device 165. In this embodiment, the utility application 140 generates a web page indicating the erasure function and the web browser 500 displays the web page. A user then provides input to the web browser 500 identifying the erasure function and the web browser 500 selects the identified erasure function based on the user input. For example, the user may select a button on the web page to identify the erasure function. The web browser 500 provides a communication to the utility application 140 identifying the erasure function. The utility application 140 selects the erasure function based on the communication received from the web browser 500 and sends an erasure command to the programmable controller 215. For example, the utility application 140 may provide an erasure command to the applet 505, and the applet 505 may provide the erasure command to the programmable controller 215.

The programmable controller 215 erases each of the flash storage 220 in the storage device 165 based on the erasure command. In some embodiments in which the messages 225 are not stored in a flash storage 220, the programmable controller 215 also erases the messages 225 based on the erasure command. In various embodiments, the processor 205 operates in conjunction with the programmable controller 215 to perform the erasure command.

In one embodiment, the utility application 140 performs a sanitizing function on a storage device 165. In this embodiment, the utility application 140 generates a web page indicating the sanitizing function and the web browser 500 displays the web page. A user then provides input to the web browser 500 indicating selection of the sanitizing function and the web browser 500 selects the sanitizing function based on the user input. For example, the user may select a button on the web page to identifying the sanitizing function. The web browser 500 provides a communication to the utility application 140 identifying the sanitizing function and the utility application 140 selects the sanitizing function based on the communication received from the web browser 500. Further, the utility application 140 sends a sanitizing command to the programmable controller 215. For example, the utility application 140 may provide a sanitizing command to the applet 505, and the applet 505 may provide the sanitizing command to the programmable controller 215.

The programmable controller 215 erases each of the flash storage 220 in the storage device 165 based on the sanitizing command. The programmable controller 215 then writes data patterns into each of the flash storage 220. In various embodiments, the programmable controller 215 writes the data patterns in each of the flash storage 220 using a standard technique, such as DoD 5220.22-M, AFSSI 5020, or NSA 130-2. In some embodiments in which the messages 225 are not stored in a flash storage 220, the programmable controller 215 also erases the messages 225 based on the sanitizing command. In various embodiments, the processor 205 operates in conjunction with the programmable controller 215 to perform the sanitizing command.

In one embodiment, the utility application 140 performs a message function on a storage device 165. In this embodiment, the utility application 140 generates a web page indicating the message function and the web browser 500 displays the web page. A user then provides input to the web browser 500 identifying the message function and the web browser 500. For example, the user may select a button on the web page to identify of the message function. The web browser 500 provides a communication identifying the message function to the utility application 140 and the utility application 140 selects the message function based on the communication received from the web browser 500. Further, the utility application 140 retrieves the messages 225 from the selected storage device 165, generates a log file 130 (e.g., a message log) based on the messages 225, and stores the log file 130 in the computing host 105.

In one embodiment, the utility application 140 sends a message command to the programmable controller 215 in selected storage device 165. For example, the utility application 140 may provide a message command to the applet 505, and the applet 505 may provide the message command to the programmable controller 215. The programmable controller 215 reads the messages 225 and transfers the messages 225 to the utility application 140 based on the message command. In turn, the utility application 140 generates the log file 130 based on the messages 225 and stores the log file 130 in the memory 110 of the computing host 105. In a further embodiment, the utility application 140 stores the log file 130 in the server 135. In some embodiments, the processor 205 operates in conjunction with the programmable controller 215, the utility application 140, and the web browser 500 to perform the message command.

In one embodiment, the utility application 140 performs a statistics function on a storage device 165. In this embodiment, the utility application 140 generates a web page indicating the statistics function and the web browser 500 displays the web page. A user then provides input to the web browser 500 identifying the statistics function. For example, the user may select a button on the web page to indicate selection of the statistics function. The web browser 500 provides a communication identifying the statistics function to the utility application 140 and the utility application 140 selects the statistics function based on the communication received from the web browser 500. The utility application 140 reads the statistics 240 from the storage device 165 and generates a web page indicating the statistics 240. Further, the web browser 500 displays the web page. Additionally, the utility application 140 may generate a log file 130 (e.g., a statistics log) based on the statistics 240 and store the log file 130 in the computing host 105.

In one embodiment, the utility application 140 performs a purge or an erase function on a storage device 165. The utility application 140 may perform the purge or erase function on more that one storage device 165 substantially simultaneously. Similarly, the utility application 140 may perform a destructive purge function, or various types of purge techniques on one or more storage devices 165, where such purging technique as is well known in the art.

In one embodiment, the utility application 140 may perform a destructive purge function on one or more storage devices 165, such as disclosed in U.S. Pat. No. 7,180,777, which is hereby incorporated by reference in its entirety.

In one embodiment, the utility application 140 may perform a redundant purge function on one or more storage devices 165, such as disclosed in U.S. patent application Ser. No. 11/582,782, which is hereby incorporated by reference in its entirety.

In one embodiment, the utility application 140 may perform a verified purge function on one or more storage devices 165, such as disclosed in U.S. patent application Ser. No. 11/582,728, which is hereby incorporated by reference in its entirety.

In one embodiment, the utility application 140 may perform a device recoverable purge function on one or more storage devices 165, such as disclosed in U.S. patent application Ser. No. 11/582,783, which is hereby incorporated by reference in its entirety.

In one embodiment, the utility application 140 may perform a function of adding a password or other device security means to one or more storage devices 165. Such passwords or other device security means are well known in the art. In yet another embodiment, the utility application 140 may perform a function of encrypting one or more storage devices 165. Various methods of encryption of a storage device are well known in the art and may be used to encrypt a storage device 165.

In one embodiment, the utility application 140 may perform a function of detecting the impending failure or calculate the remaining device life of one or more storage devices 165. For example, the function of detecting impending failure may be such as disclosed in U.S. patent application Ser. No. 10/943,483, which is hereby incorporated by reference in its entirety.

In one embodiment, the utility application 140 may perform various query functions on one or more storage devices 165, such as, for example, queries on the number of spare storage spaces or blocks available, the number of defects, the number of grown defects, the amount or pre-existing defects, the amount of free space or free blocks, and similar such queries. These queries may also be in the form of detecting a percentage or ratio, such as the percentage of spares available, percentage of storage space available, ratio of defects to available space, and the like.

In one embodiment, the utility application 140 may perform a function on one or more storage devices 165 to alter the memory 110, such as a function to erase the log file 130 or to erase the memory 110. The alteration of memory 110 may be performed as part of another function, such as a purge, destructive purge, erase or encryption, or the like, or as a distinct function.

In one embodiment, the utility application 140 sends a statistics command to the programmable controller 215 in selected storage device 165. For example, the utility application 140 may provide a statistics command to the applet 505, and the applet 505 may provide the statistics command to the programmable controller 215. The programmable controller 215 reads the statistics 240 and transfers the statistics 240 to the utility application 140, based on the statistics command. In addition to the statistics 240, the utility application 140 may compute other statistics and generate a web page indicating these other statistics, as is described more fully herein. In some embodiments, the processor 205 operates in conjunction with the programmable controller 215 to perform the statistics command.

In one embodiment, the utility application 140 also generates a trend plot on a web page based on the statistics 240. For example, a user may provide a communication to the utility application 140 via the user interface 115 indicating that the trend plot is to be generated. In turn, the utility application 140 generates the trend plot based on the statistics 240. In various embodiments, the processor 205 operates in conjunction with the programmable controller 215, the utility application 140, or the user interface 115, or any combination thereof, to perform the statistics command.

In various embodiments, the statistics 240 include counts of the number of read commands (e.g., host read commands) and write commands (e.g., host write commands) received by the storage device 165 from the computing host 105 and counts of the number or read and write operations performed by the storage device 165 on the flash storage 220 during one or more reporting periods. The reporting periods may include the time since power up of the storage device 165 as well as various time intervals since power up of the storage device 165. In one embodiment, a reporting period is a predetermined time interval and the storage device 165 may generate the counts during successive predetermined time intervals since power up of the storage device 165. For example, the predetermined time interval may be five minutes. Additionally, the storage device 165 may generate counts for a current reporting period, which is less than the predetermined time interval.

In addition to commands received from the computing host 105 and operations performed by the storage device 165 on the flash storage 220, the storage device 165 may generate counts for events occurring during operation of the storage device 165, which indicate performance of the storage device 165. For example, the counts may include a number of byte blocks (e.g., 512 byte blocks) requested in a read command or write command received from the computing host 105 in a reporting period. Further, the utility application 140 may compute an average read size statistic by dividing the number of byte blocks requested in read commands received during a reporting period by the storage device 165 from the computing host 105 in the reporting period. Similarly, the utility application 140 may compute an average write size statistic by dividing the number of byte blocks in write commands received by the storage device 165 from the computing host 105 in a reporting period by the number of write commands received by the storage device 165 from the computing host 105 in the reporting period.

In some embodiments, the memory module 230 of the storage device 165 includes a cache memory. For example, the SDRAM 335 may function as a cache memory. In these embodiments, the storage device 165 may generate a count of the number of read commands received from the computing host 105 during a reporting period that were serviced in the cache memory without a need for performing a read operation in the flash storage 220. Similarly, the storage device 165 may generate a count of the number of write commands received from the computing host 105 during a reporting period that were serviced in the cache memory without performing a read or write operation in the flash storage 220. Further, the utility application 140 may compute a percentage of read commands performed on the cache memory during a reporting period by dividing the number of read commands serviced in the cache memory without performing a read operation in the flash storage 220 during the reporting period by the number of read commands received from the computing host 105 during the reporting period. Similarly, the utility application 140 may compute a percentage of write commands performed on the cache memory during a reporting period by dividing the number of write commands serviced in the cache memory without performing a read or write operation in the flash storage 220 during the reporting period by the number of write commands received from the computing host 105 during the reporting period.

The storage device 165 may maintain a count of the number of byte blocks read from the cache memory for read commands serviced in the cache memory during a reporting period. Further, the utility application 140 may compute a percentage of byte blocks read from the cache memory for read commands received by the storage device 165 during a reporting period by dividing the number of byte blocks read from the cache memory in the read commands during the reporting period by the number of byte blocks read from the storage device 165 in the read commands during the reporting period. Similarly, the storage device 165 may maintain a count of the number of byte blocks written to the cache memory for write commands serviced in the cache memory during a reporting period. Further, the utility application 140 may compute a percentage of byte blocks written to the cache memory for write commands received by the storage device 165 in a reporting period by dividing the count of the number of byte blocks written to the cache memory in the write commands in the reporting period by the number of byte blocks written to the storage device 165 in the write commands during the reporting period.

Additionally, the utility application 140 may compute the average size of read commands serviced in the cache memory during a reporting period by dividing the number of byte blocks read from the cache memory in the read commands serviced by the cache memory during the reporting period by the number read commands serviced in the cache memory during the reporting period. Similarly, the utility application 140 may compute the average size of write commands serviced in the cache memory during a reporting period by dividing the number of byte blocks written to the cache memory in the write commands serviced by the cache memory during the reporting period by the number write commands serviced in the cache memory during the reporting period.

The statistics 240 may include a count of the number of read commands that were stalled in the storage device 165 during a reporting period, for example because of a lack of resources in the storage device 165 during the reporting period. For example, the storage device 165 may maintain a command queue for commands received from the computing host 105, and a read command received from the computing host 105 may stall if the command queue is full. Other examples of a lack of resources include a low availability of cache pages or contention of cache pages in the storage device 165. The utility application 140 may compute a statistic of the percentage of read commands stalled in the storage device 165 during a reporting period by dividing the number of read commands that were stalled in the storage device 165 during the reporting period by the number of read commands received by the storage device 165 from the computing host 105 in the reporting period.

The statistics 240 may include a count of the number of write commands that were stalled in the storage device 165 during a reporting period, for example because of a lack of resources in the storage device 165 during the reporting period. For example, the storage device 165 may maintain a command queue for commands received from the computing host 105, and a write command received from the computing host 105 may stall if the command queue is full. Other examples of a lack of resources include a low availability of cache pages or contention of cache pages in the storage device 165. The utility application 140 may compute a statistic of the percentage of write commands stalled in the storage device 165 during a reporting period by dividing the number of write commands that were stalled in the storage device 165 during the reporting period by the number of write commands received by the storage device 165 from the computing host 105 in the reporting period. Generally, a relatively high percentage of write commands stalled in the storage device 165 during a reporting period indicates that the data stored in the storage device 165 should be distributed among multiple storage devices 165.

The statistics 240 may include a count of the number of write commands received by the storage device 165 from the computing host 105 during a reporting period that start on a non-aligned boundary. For example, the storage device 165 may store data aligned on 4K boundaries and the statistics 240 include a count of the number of write commands received by the storage device 165 from the computing host 105 during a reporting period that do not start on a 4K boundary. Generally, the storage device 165 takes longer to store data in the flash storage 220 that start on a non-aligned boundary because the storage device 165 performs multiple write operations on the flash storage 220.

Additionally, the utility application 140 may compute a percentage of write commands received from the computing host 105 during a reporting period that start on a non-aligned boundary by dividing the number of write commands received from the computing host 105 during the reporting period that start on a non-aligned boundary by the number of write commands received from the computing host 105 during the reporting period. Generally, a relatively high percentage of write commands received from the computing host 105 during a reporting period that start on a non-aligned boundary indicates that the file system of the computing host 105 should be reset, for example by using a diskpart utility. Additionally, the statistics 240 may include a count of the number of read operation performed on the flash storage 220 for a write command received from the computing host 105 that is on a non-aligned boundary.

The statistics 240 may also include a number of write commands received by the storage device 165 from the computing host 105 that end on a non-aligned boundary. Additionally, the utility application 140 may compute a percentage of write commands received from the computing host 105 during a reporting period that end on a non-aligned boundary by dividing the number of write commands received from the computing host 105 during the reporting period that end on a non-aligned boundary by the number of write commands received from the computing host 105 during the reporting period.

Further, the statistics 240 may include a count of the number of read operations performed on the flash storage 220 during a reporting period. Generally, the number of read operations performed on the flash storage 220 during a reporting period is higher than the number of read commands received from the computing host 105 during the reporting period because the storage device 165 may distribute data across multiple flash storage 220 by performing multiple read operations for the write command.

The statistics 240 may also include a count of the number of byte blocks (e.g., 512K byte blocks) read from the flash storage 220 during a reporting period. Further, the utility application 140 may compute the average size of data read from the flash storage 220 in a read command during a reporting period by dividing the number of byte blocks read from the flash storage 220 during the reporting period by the number of read commands received from the computing host 105 during the reporting period. Additionally, the utility application 140 may compute the percentage of data read from the flash storage 220 during a reporting period by dividing the number of byte blocks read from the flash storage 220 during the reporting period by the number of byte blocks read from the storage device 165 during the reporting period.

The statistics 240 may also include a count of the number of byte blocks (e.g., 512K byte blocks) written to the flash storage 220 during a reporting period. Further, the utility application 140 may compute the average size of data written to the flash storage 220 in a write command during a reporting period by dividing the number of byte blocks written to the flash storage 220 during the reporting period by the number of write commands received from the computing host 105 during the reporting period. Additionally, the utility application 140 may compute the percentage of data written to the flash storage 220 during a reporting period by dividing the number of byte blocks written to the flash storage 220 during the reporting period by the number of byte blocks written to the storage device 165 during the reporting period. Generally, a percentage of data written to the flash storage 220 during a reporting period that is less than one-hundred percent indicates that the storage device 165 has combined one or more write commands by performing a single write operation on the flash storage 220.

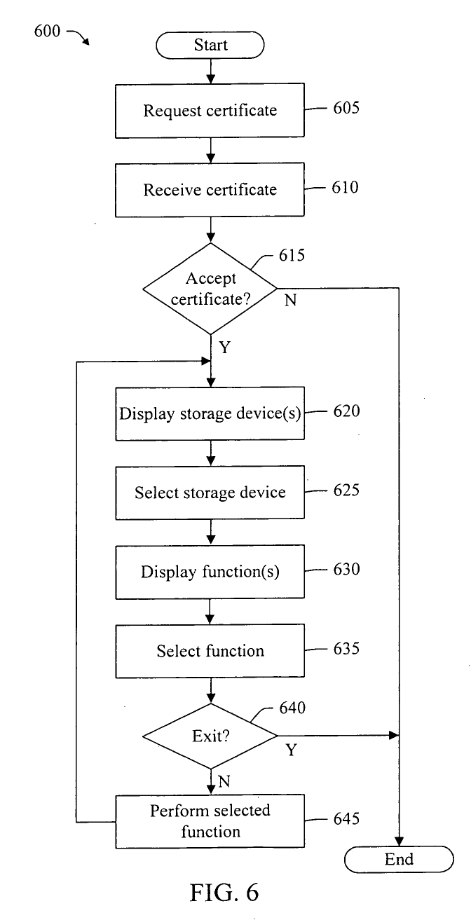

FIG. 6 illustrates a method 600 of managing a storage device 165, in accordance with the present invention. In step 605, the user interface 115 requests a certificate 125 from the utility application 140. In one embodiment, the user interface 115 includes the web browser 500. In this embodiment, the utility application 140 generates a web page including a button for selecting the certificate 125 and the web browser 500 displays the web page. A user selects the button on a web page generated by the utility application 140 and the web browser 500 sends a communication to the utility application 140 through the communication network 145 requesting the certificate 125. The method 600 then proceeds to step 610.

In step 610, the user interface 115 receives the certificate 125 from the utility application 140. In one embodiment, the utility application 140 sends the certificate 125 to the web browser 500 through the communication network 145 and the web browser 500 receives the certificate 125. The method 600 then proceeds to step 615.

In step 615, the user interface 115 determines whether to accept the certificate 125. The user interface 115 may determine whether to accept the certificate 125, for example, based on user input to the user interface 115. In one embodiment, a user selects a button on the web page generated by the utility application 140 and the web browser 500 determines whether to accept the certificate 125 based on the selected button. If the user interface 115 determines the certificate 125 is accepted, the method 600 proceeds to step 620, otherwise the method 600 ends.

In step 620, arrived at from the determination in step 615 that the certificate 125 is accepted or step 645 in which the user interface 115 has performed a previously selected function, the user interface 115 displays one or more available storage devices 165 coupled to the computing host 105. In one embodiment, the utility application 140 generates a web page indicating any available storage devices 165 coupled to the computing host 105 and the web browser 500 displays the web page. The method 600 then proceeds to step 625.

In step 625, the utility application 140 selects an available storage device 165. The utility application 140 may select the available storage device 165, for example, based on a communication from the user interface 115. In one embodiment, a user selects a button on the web page generated by the utility application 140 to identify an available storage device 165 and the web browser 500 provides a communication indicating the identified storage device 165 to the utility application 140. In turn, the utility application 140 selects the identified storage device 165 based on the communication. The method 600 then proceeds to step 630.

In step 630, the user interface 115 displays one or more functions available for selection. In one embodiment, the utility application 140 generates a web page indicating any function available for selection and the web browser 500 displays the web page. The method 600 then proceeds to step 635.

In step 635, the utility application 140 selects a function displayed on the web page. The utility application 140 may select the function, for example, based on a communication from the user interface 115. In one embodiment, a user selects a button on the web page generated by the utility application 140 to identify a function and the web browser 500 provides a communication indicating the identified function to the utility application 140. In turn, the utility application 140 selects the identified function based on the communication. The method 600 then proceeds to step 640.

In step 640, the utility application 140 determines whether the selected function is an exit function. If the selected function is the exit function, the method 600 ends, otherwise the method 600 proceeds to step 645.

In step 645, arrived at from the determination in step 640 that the selected function is not the exit function, the utility application 140 performs the selected function on the selected storage device 165. Depending upon the selected function, the utility application 140 may operate in conjunction with the user interface 115 to perform the selected function. Additionally, various components of the selected storage device 165 may operate in conjunction with the utility application 140 to perform the selected function. In some embodiments, the utility application 140 operates in conjunction with the web browser 500, the applet 505, and the java runtime environment 510 to perform the selected function. The method 600 then returns to step 620.

In various embodiments, some of the steps 605-645 of the method 600 may be performed substantially in parallel with each other or in a different order than that described above and illustrated in FIG. 6. In some embodiments, the method 600 may perform more or fewer steps than that described above and illustrated in FIG. 6.

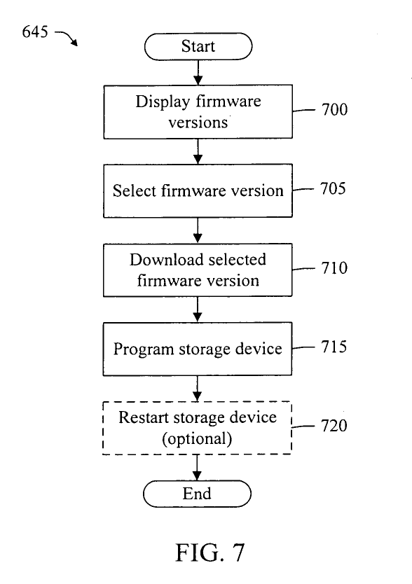

FIG. 7 illustrates a portion of the method 600 of managing the storage device 165, in accordance with an embodiment of the present invention. This portion of the method 600 is an embodiment of step 645 in which the selected function is the firmware update function. In step 700, the user interface 115 displays one or more firmware versions available for selection. In one embodiment, the utility application 140 generates a web page indicating any firmware version available for selection and the web browser 500 displays the web page. The method 600 then proceeds to step 705.

In step 705, the utility application 140 selects a firmware version displayed on the web page. The utility application 140 may select the firmware version, for example, based on a communication from the user interface 115. In one embodiment, a user selects a button on the web page generated by the utility application 140 to identify a firmware version and the web browser 500 provides a communication identifying the firmware version to the utility application 140. In turn, the utility application 140 selects the firmware version based on the communication. The method 600 then proceeds to step 710.

The utility application 140 may select the function, for example, based on a communication from the user interface 115. In one embodiment, a user selects a button on the web page generated by the utility application 140 and the web browser 500 provides a communication indicating the selected button to the utility application 140. In turn, the utility application 140 selects the function based on the communication. The method 600 then proceeds to step 640.

In step 710, the utility application 140 downloads the selected firmware version to the computing host 105. In one embodiment, the utility application 140 sends the selected firmware version to the selected storage device 165. The selected firmware version may be a file or a message containing code or instructions for updating the selected storage device 165 to the selected firmware version. The method 600 then proceeds to step 715.

In step 715, the utility application 140 programs the selected storage device 165 with the selected firmware version. In one embodiment, the utility application 140 sends a firmware update command to the selected storage device 165 for performing the firmware update function. In various embodiments, the utility application 140 operates in conjunction with the user interface 115, the programmable controller 215, or the processor 205, or any combination thereof, to program the selected storage device 165 with the selected firmware version. In a further embodiment, the utility application 140 disables other input/output operations between the computing host 105 and the selected storage device 165 during the process of programming the selected storage device 165 with the selected firmware version. The method 600 then proceeds to step 720.

In optional step 720, the utility application 140 restarts the selected storage device 165. In one embodiment, the utility application 140 operates in conjunction with the web browser 500 and the applet 505 to assert a reset signal in the selected storage device 165. This portion of the method 600 then ends.

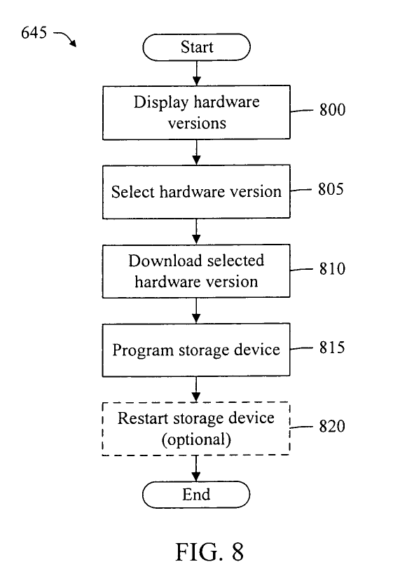

FIG. 8 illustrates a portion of the method 600 of managing the storage device 165, in accordance with an embodiment of the present invention. This portion of the method 600 is an embodiment of step 645 in which the selected function is the hardware update function. In step 800, the user interface 115 displays one or more hardware versions available for selection. In one embodiment, the utility application 140 generates a web page indicating any hardware version available for selection and the web browser 500 displays the web page. The method 600 then proceeds to step 805.

In step 805, the utility application 140 selects a hardware version displayed on the web page. The utility application 140 may select the hardware version, for example, based on a communication from the user interface 115. In one embodiment, a user selects a button on the web page generated by the utility application 140 to identify the hardware version and the web browser 500 provides a communication identifying the hardware version to the utility application 140. In turn, the utility application 140 selects the hardware version based on the communication. The method 600 then proceeds to step 810.

In step 810, the utility application 140 downloads the selected hardware version to the computing host 105. In one embodiment, utility application 140 sends the selected hardware version to the selected storage device 165. The selected hardware version may be a file or a message containing code or instructions for updating the selected storage device 165 to the selected hardware version. The method 600 then proceeds to step 815.

In step 815, the utility application 140 programs the selected storage device 165 with the selected hardware version. In one embodiment, the utility application 140 sends a hardware update command to the selected storage device 165 for performing the hardware update function. In various embodiments, the utility application 140 operates in conjunction with the user interface 115, the processor 205, or the programmable controller 215, or any combination thereof, to program the selected storage device 165 with the selected hardware version. In a further embodiment, the utility application 140 disables other input/output operations between the computing host 105 and the selected storage device 165 during the process of programming the selected storage device 165 with the selected hardware version. The method 600 then proceeds to step 820.

In optional step 820, the utility application 140 restarts the selected storage device 165. In one embodiment, the utility application 140 operates in conjunction with the web browser 500, the applet 505, and the runtime environment 510 to restart the selected storage device 165 by asserting a reset signal in the selected storage device 165. This portion of the method 600 then ends.

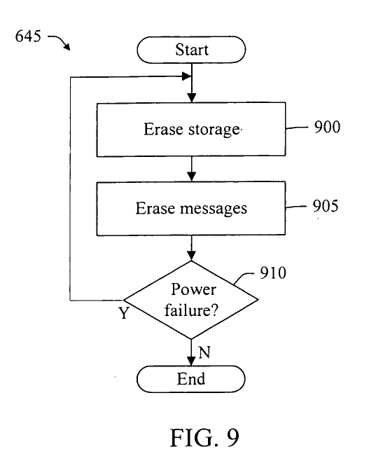

FIG. 9 illustrates a portion of the method 600 of managing the storage device 165, in accordance with an embodiment of the present invention. This portion of the method 600 is an embodiment of step 645 in which the selected function is the erasure function. In step 900, the utility application 140 erases the selected storage device 165. In one embodiment, the utility application 140 sends an erasure command to the selected storage device 165 for performing the erasure function. In various embodiments, the utility application 140 operates in conjunction with the user interface 115, the processor 205, or the programmable controller 215, or any combination thereof, to erase the selected storage device 165 by erasing each of the flash storage 220 in the selected storage device 165. The method 600 then proceeds to step 905.

In step 905, the utility application 140 erases any messages 225 stored in the selected storage device 165. In various embodiments, the user interface 115 operates in conjunction with the processor 205 and the programmable controller 215, or both, to erase any messages 225 stored in the selected storage device 165. The method 600 then proceeds to step 910.

In step 910, the utility application 140 determines whether a power failure occurred during erasure of the selected storage device 165 in step 900 or step 905. In one embodiment, the programmable controller 215 detects a power failure and the user interface 115 sends a communication to the utility application 140 indicating the power failure. In turn, the utility application 140 determines whether a power failure occurred based on the communication. If a power failure occurred during erasure of the selected storage device 165, the method 600 returns to step 900 and the utility application 140 performs the erasure function a second time, otherwise this portion of the method 600 ends.

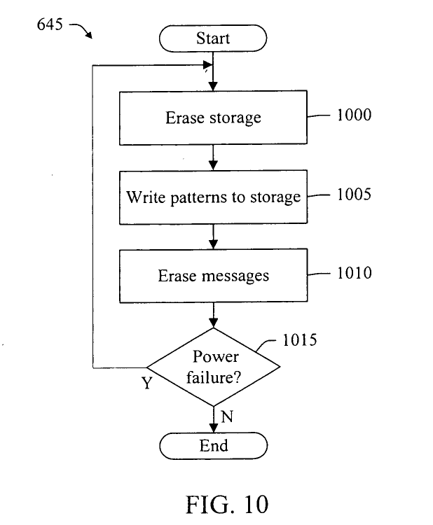

FIG. 10 illustrates a portion of the method 600 of managing the storage device 165, in accordance with an embodiment of the present invention. This portion of the method 600 is an embodiment of step 645 in which the selected function is the sanitizing function. In step 1000, the utility application 140 erases the selected storage device 165. In one embodiment, the utility application 140 sends a sanitizing command to the programmable controller 215 for performing the sanitizing function. In various embodiments, the utility application 140 operates in conjunction with the user interface 115, the processor 205, or the programmable controller 215, or any combination thereof, to erase the selected storage device 165 by erasing each of the flash storage 220 in the selected storage device 165. The method 600 then proceeds to step 1005.

In step 1005, the utility application 140 writes data patterns into the selected storage device 165 to remove any residual portions of data remaining in the selected storage device 165. A residual portion of data may be data that is not readable by the selected storage device 165 but may be readable by equipment external of the selected storage device 165. An example of residual data in a storage device that includes disk storage is magnetic properties around the edges of a disk sector that has been erased. This residual data remains in the disk sector because the erasure of the disk section is imperfect as a result of imprecise alignment of a disk head in the disk storage. Writing data patterns to this disk sector tends to diminish the residual data in the disk sector, particularly when the different data patterns are written to the disk sector after erasure of the disk sector. In one embodiment, the utility application 140 sends write commands to the programmable controller 215 for writing the data patterns into each of the flash storage 220 of the selected storage device 165 and the programmable controller 215 writes data patterns in the selected storage device 165 based on the write commands. In various embodiments, the utility application 140 operates in conjunction with the user interface 115, the processor 205, or the programmable controller 215, or any combination thereof, to write data patterns in the selected storage device. The method 600 then proceeds to step 1010.

In step 1010, the utility application 140 erases any messages 225 stored in the selected storage device 165. In various embodiments, the utility application 140 operates in conjunction with the user interface 115, the processor 205, or the programmable controller 215, or any combination thereof, to erase any messages 225 stored in the selected storage device 165. The method 600 then proceeds to step 1015.

In step 1015, the utility application 140 determines whether a power failure occurred during sanitization of the selected storage device 165 in step 1000, step 1005, or step 1010. In one embodiment, the programmable controller 215 detects a power failure and the user interface 115 sends a communication to the utility application 140 indicating the power failure. In turn, the utility application 140 determines whether a power failure occurred based on the communication. If a power failure occurred during sanitation of the selected storage device 165, the method 600 returns to step 1000 and the utility application 140 performs the sanitization function a second time, otherwise this portion of the method 600 ends.

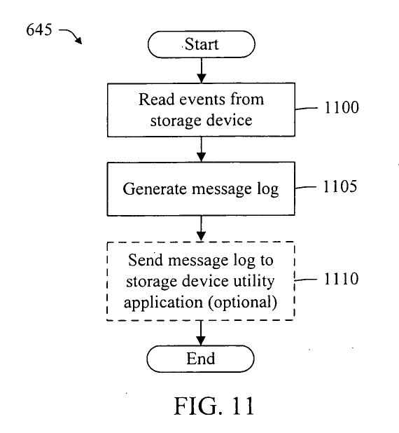

FIG. 11 illustrates a portion of the method 600 of managing the storage device 165, in accordance with an embodiment of the present invention. This portion of the method 600 is an embodiment of step 645 in which the selected function is the message download function. In step 1100, the utility application 140 reads messages 225 from the selected storage device 165. In one embodiment, the utility application 140 sends a message command to the selected storage device 165 perform the message function and the selected storage device 165 reads the messages 225 from the selected storage device 165 based on the message command. In various embodiments, the utility application 140 operates in conjunction with the user interface 115, the processor 205, or the programmable controller 215, or any combination thereof, to read the messages 225 from the selected storage device 165. The method 600 then proceeds to step 1105.

In step 1105, the utility application 140 generates a log file 130 based on the messages 225. In one embodiment, the utility application 140 generates the log file 130 by storing a message log in the computing host 105. The method 600 then proceeds to step 1110.

In optional step 1110, the utility application 140 uploads the message log to the server 135 through the communication network 145. This portion of the method 600 then ends.

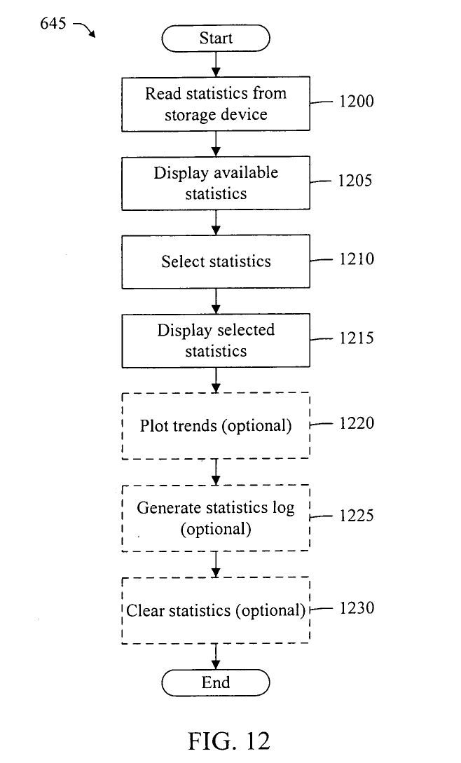

FIG. 12 illustrates a portion of the method 600 of managing the storage device 165, in accordance with an embodiment of the present invention. This portion of the method 600 is an embodiment of step 645 in which the selected function is the statistics function. In step 1200, the utility application 140 reads statistics 240 from the selected storage device 165. In one embodiment, the utility application 140 sends a statistics command to the selected storage device 215 for reading the statistics 240 and the selected storage device 165 reads the statistics 240 from the selected storage device 165 based on the statistics command. In various embodiments, the utility application 140 operates in conjunction with the user interface 115, the processor 205, or the programmable controller 215, or any combination thereof, to read the statistics 240 from the selected storage device 165. The method 600 then proceeds to step 1205.

In step 1205, the user interface 115 displays statistics 240 available for selection. In one embodiment, the utility application 140 generates a web page indicating statistics 240 available for selection and the web browser 500 displays the webpage. The method 600 then proceeds to step 1210.

In step 1210, the user interface 115 selects a statistic. In one embodiment, a user selects a button on the web page generated by the utility application 140 to identify a statistic and the web browser 500 provides a communication identifying the statistic to the utility application 140. In turn, the utility application 140 selects the identified statistic based on the communication received from the web browser 500. The method 600 then proceeds to step 1215.

In step 1215, the user interface 115 displays the selected statistic. In one embodiment, the utility application 140 computes the selected statistic based on the statistics 240 read from the storage device 165 and generates a webpage containing the selected statistic. In turn, the web browser 500 displays the selected statistic. The method 600 then proceeds to step 1220.

In optional step 1220, the user interface 115 displays a trend plot for the selected statistic. In one embodiment, the utility application 140 generates a web page indicating a plot of a trend for the selected statistic and the web browser 500 displays the webpage. The method 600 then proceeds to step 1225.

In optional step 1225, the utility application 140 generates a log file 130 based on the messages 225. In one embodiment, the utility application 140 generates the log file 130 by storing a statistics log in the computing host 105. The method 600 then proceeds to step 1230.

In optional step 1230, the utility application 140 clears the statistics 240 from the selected storage device 165. In one embodiment, a user selects a button on the webpage generated by the utility application 140 to indicate the statistics 240 are to be cleared and the web browser 500 sends a communication to the utility application 140 indicating that the statistics 240 are to be cleared. In turn, the utility application 140 clears the statistics 240 from the selected storage device 165 based on the communication received from the web browser 500. In some embodiments, the utility application 140 clears the statistics 240 from the selected storage device 165 by sending a clear statistics command to the selected storage device 165 and the selected storage device 165 clears the statistics based on the clear statistics command. In various embodiments, the utility application 140 operates in conjunction with the user interface 115, the processor 205, or the programmable controller 215, or any combination thereof, to clear the statistics 240 from the selected storage device 165. This portion of the method 600 then ends.

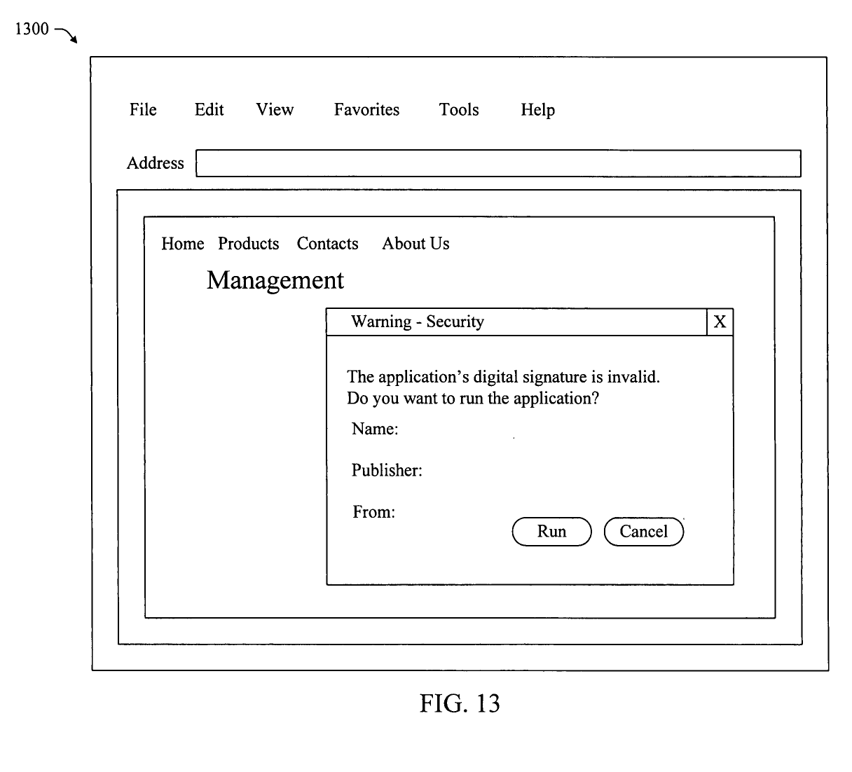

FIG. 13 illustrates an exemplary web page 1300, in accordance with an embodiment of the present invention. The web page 1300 displays an indication that the certificate 125 received by the web browser 500 from the utility application 140 is invalid. The web browser 500 generates the web page 1300 during management of the storage devices 165.

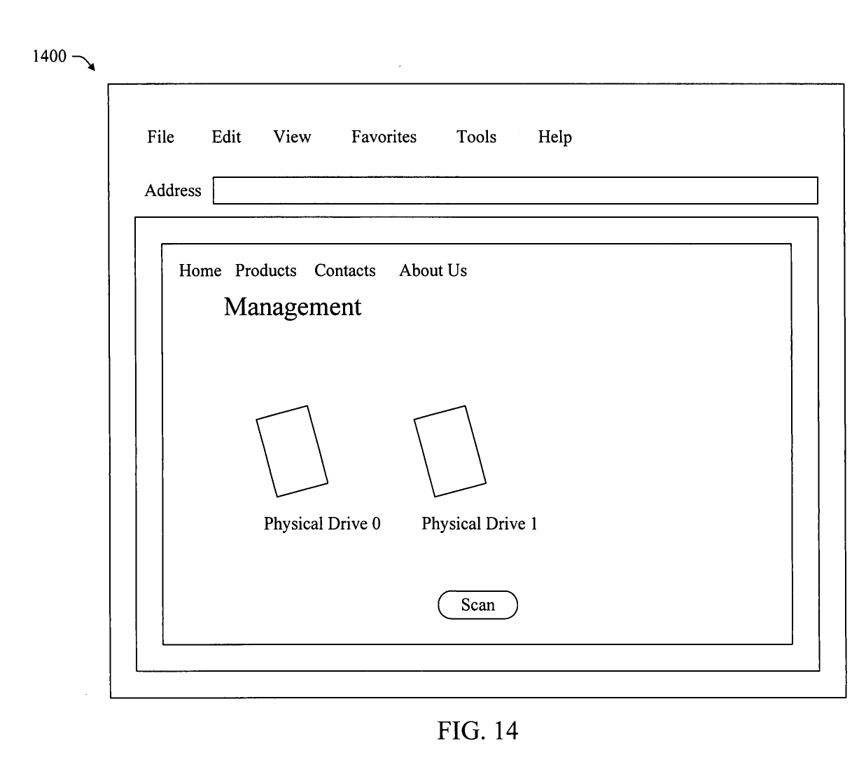

FIG. 14 illustrates an exemplary web page 1400, in accordance with an embodiment of the present invention. The web page 1400 displays two storage devices 165 available for selection through the web browser 500. The utility application 140 generates the web page 1400 during management of the storage devices 165.

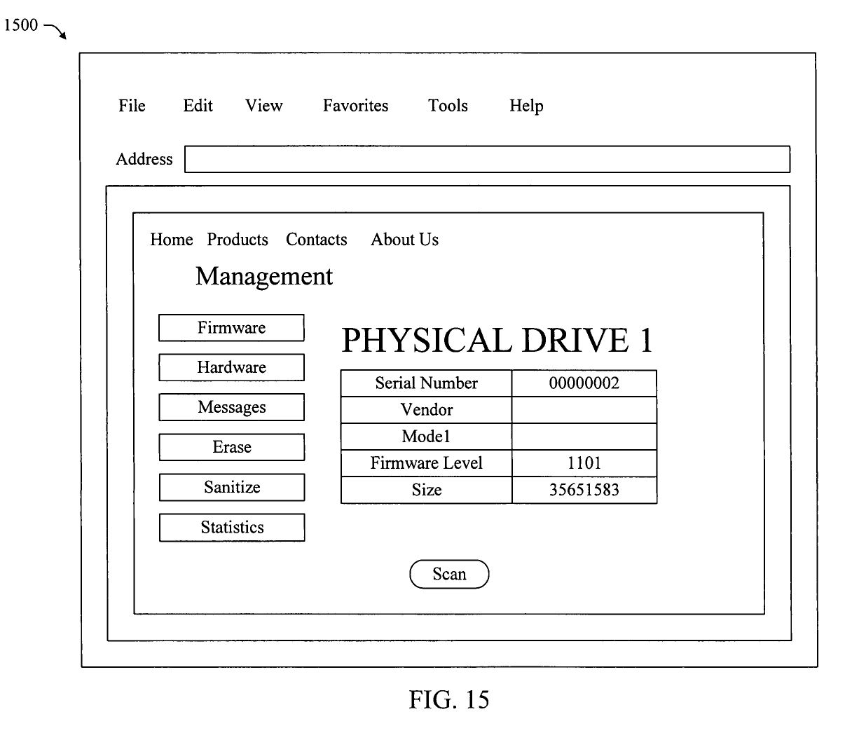

FIG. 15 illustrates an exemplary web page 1500, in accordance with an embodiment of the present invention. The web page 1500 displays functions available for selection through the web browser 500. The utility application 140 generates the web page 1500 during management of a selected storage device 165.

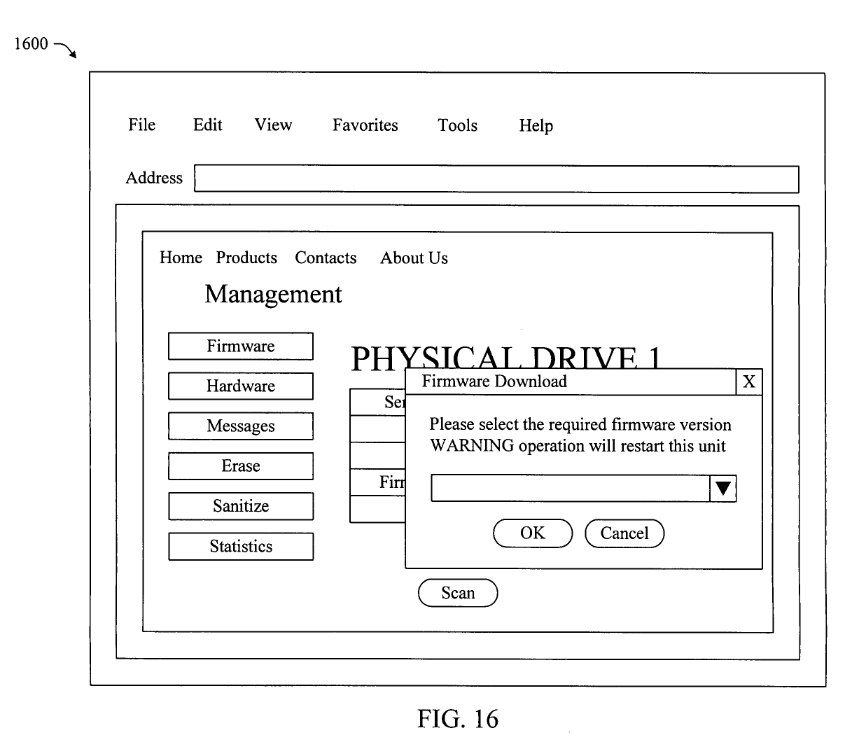

FIG. 16 illustrates an exemplary web page 1600, in accordance with an embodiment of the present invention. The web page 1600 displays firmware versions available in the firmware update function. The utility application 140 generates the web page 1600 after a user provides input to the web browser 500 identifying the firmware function.

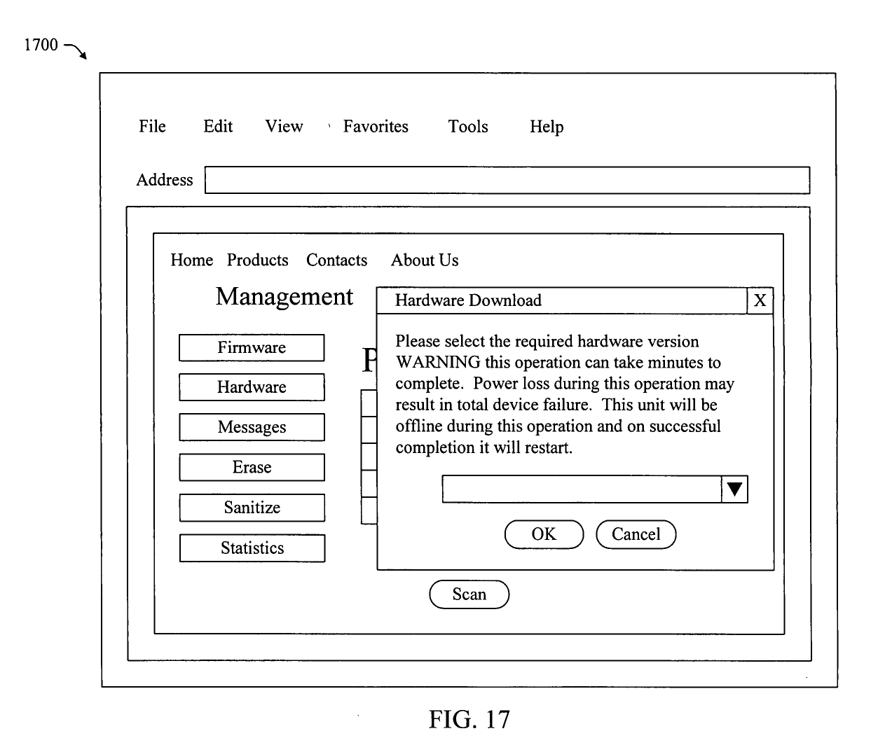

FIG. 17 illustrates an exemplary web page 1700, in accordance with an embodiment of the present invention. The web page 1700 displays hardware versions available in the hardware update function. The utility application 140 generates the web page 1700 after a user provides input to the web browser 500 identifying the hardware function.

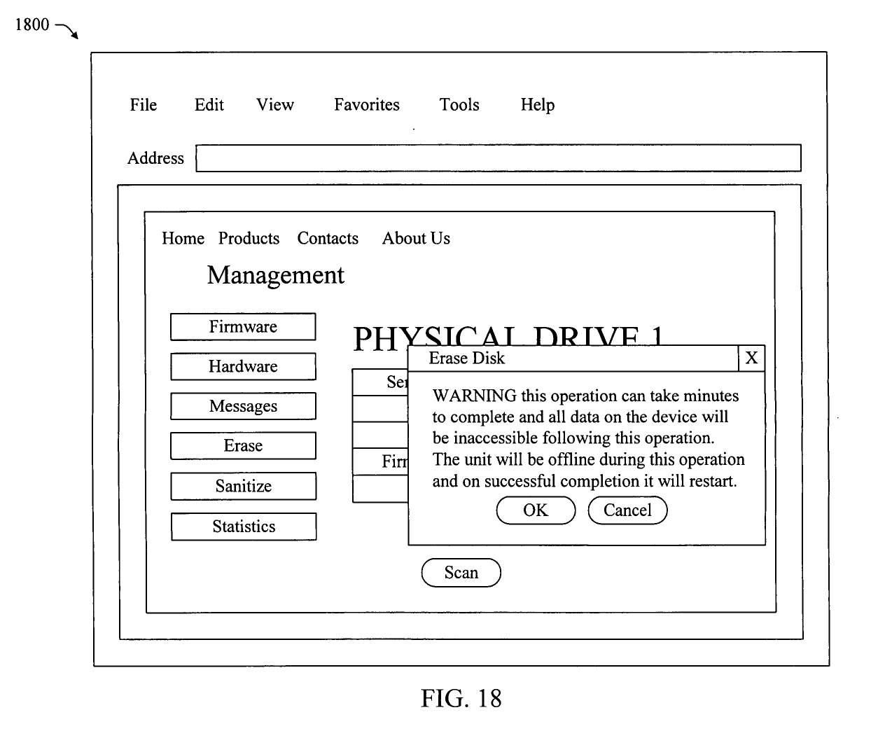

FIG. 18 illustrates an exemplary web page 1800, in accordance with an embodiment of the present invention. The web page 1800 displays status information for the erase function. The utility application 140 generates the web page 1800 after a user provides input to the web browser 500 identifying the erasure function.

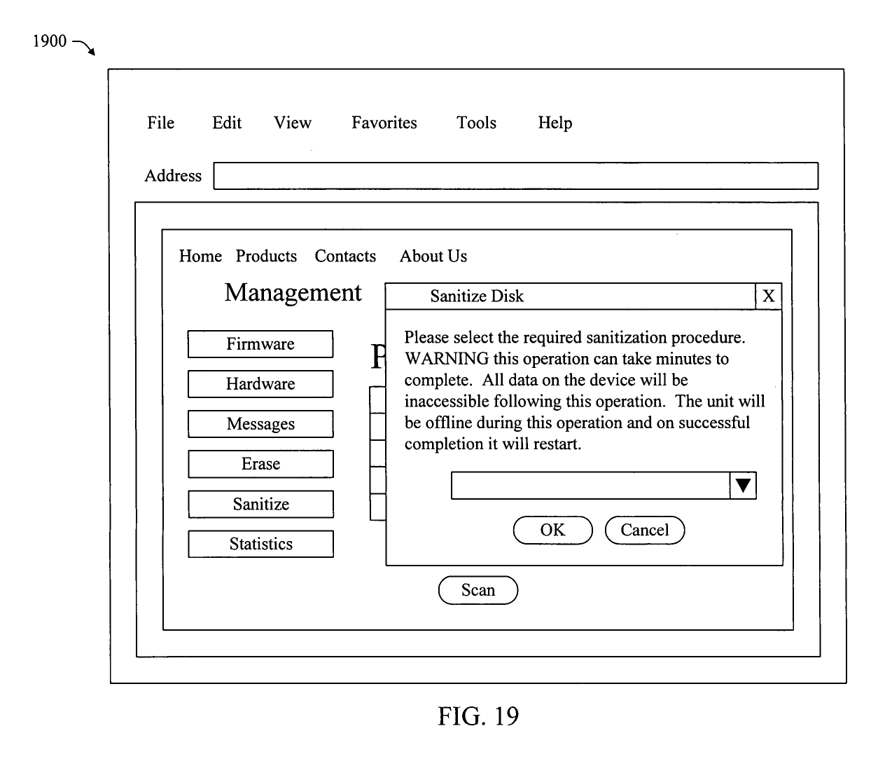

FIG. 19 illustrates an exemplary web page 1900, in accordance with an embodiment of the present invention. The web page 1900 displays algorithms available for the sanitize function. The utility application 140 generates the web page 1900 after a user provides input to the web browser 500 identifying the sanitize function.

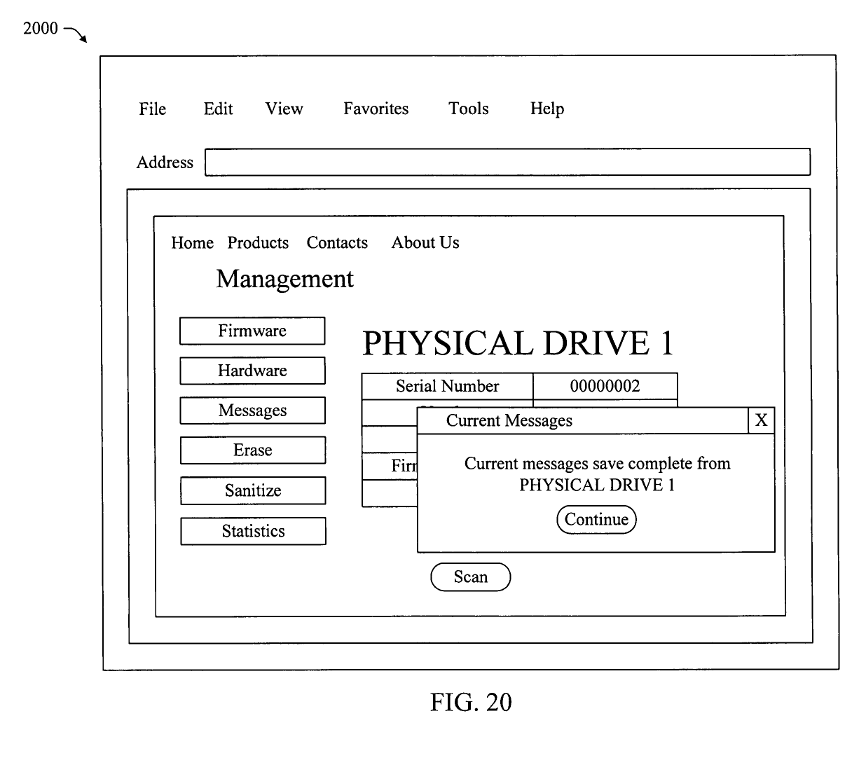

FIG. 20 illustrates an exemplary web page 2000, in accordance with an embodiment of the present invention. The web page 2000 displays status information for the message download function. The utility application 140 generates the web page 2000 after a user provides input to the web browser 500 identifying the message function.

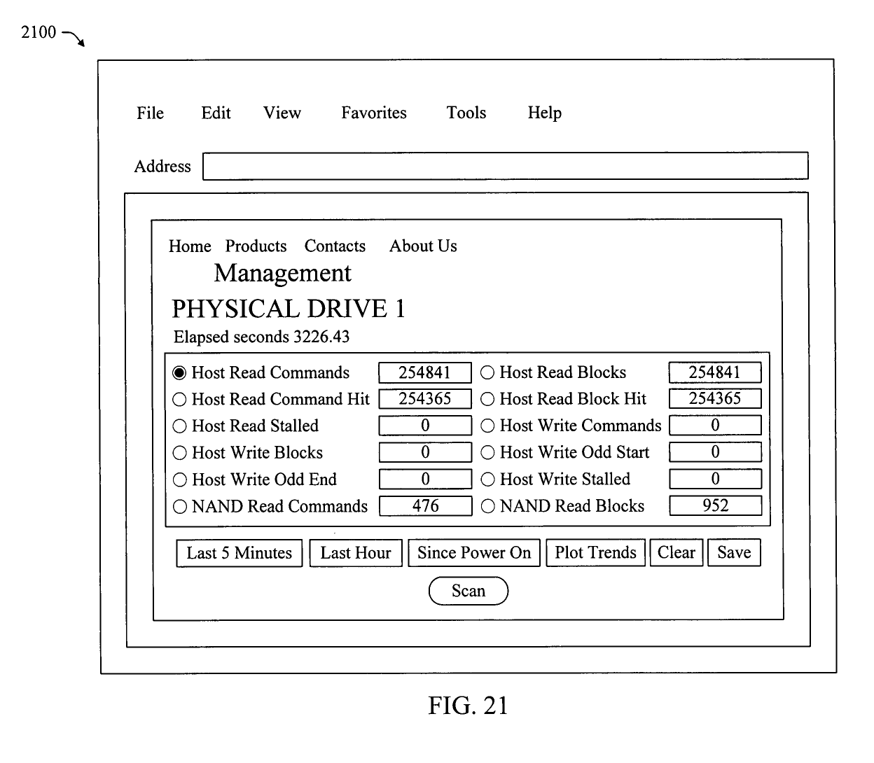

FIG. 21 illustrates an exemplary web page 2100, in accordance with an embodiment of the present invention. The web page 2100 displays statistics (e.g., statistics 240) for the selected storage device 165. The utility application 140 generates the web page 2100 after a user provides input to the web browser 500 identifying the statistics function.

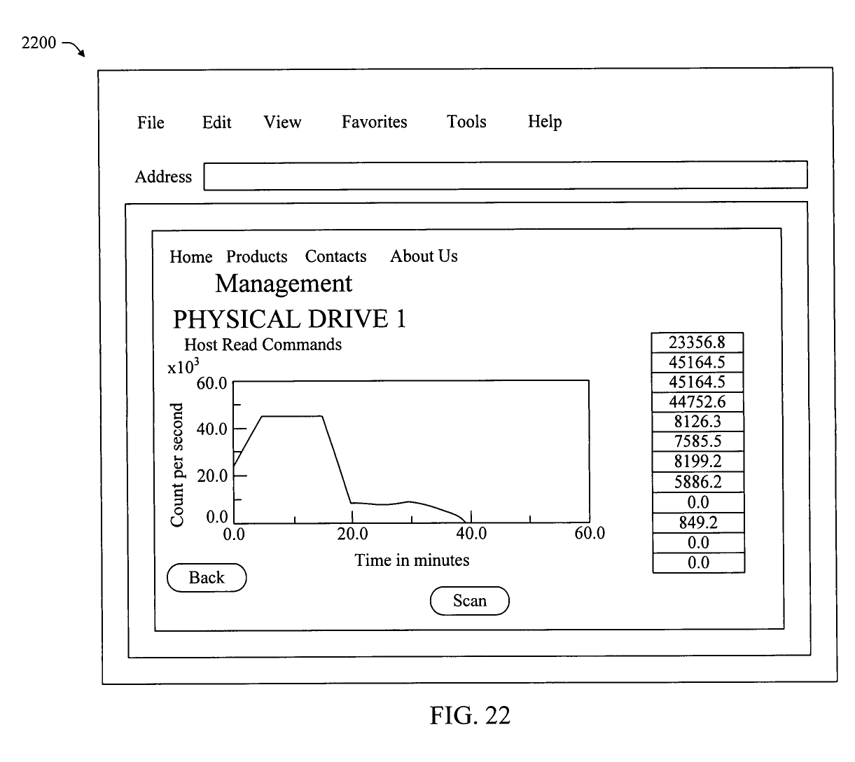

FIG. 22 illustrates an exemplary web page 2200, in accordance with an embodiment of the present invention. The web page 2200 displays a plot of statistical trends for a storage device 165. The utility application 140 generates the web page 2200 after a user provides input to the web browser 500 identifying of a plot trend variation of the statistics function.

Although the invention has been described with reference to particular embodiments thereof, it will be apparent to one of ordinary skill in the art that modifications to the described embodiment may be made without departing from the spirit of the invention. Accordingly, the scope of the invention will be defined by the attached claims not by the above detailed description.

What is claimed is:

1. A method of altering the contents of a storage device, the method comprising:
generating a web page indicating at least one storage device;
selecting a storage device of the at least one storage device;
generating a web page indicating at least one function;
selecting a function of the at least one function; and
performing the selected function on the selected storage device, wherein the selected function of the at least one function performs an alteration of the contents of the selected storage device.

2. The method of claim 1, wherein the alteration of the contents of the selected storage device comprises a purge of the selected storage device.

3. The method of claim 1, wherein the alteration of the contents of the selected storage device comprises a destructive purge of the selected storage device.

4. The method of claim 1, wherein the alteration of the contents of the selected storage device comprises a verified purge of the selected storage device.

5. The method of claim 1, wherein the alteration of the contents of the selected storage device comprises a device recoverable purge of the selected storage device.

6. The method of claim 1, wherein the alteration of the contents of the selected storage device comprises a redundant purge of the selected storage device.

7. The method of claim 1, wherein the alteration of the contents of the selected storage device comprises an encryption of the selected storage device.

8. The method of claim 1, wherein the alteration of the contents of the selected storage device comprises a security access lock of the selected storage device.

9. The method of claim 1, wherein the alteration of the contents of the selected storage device comprises a password lock of the selected storage device.

10. The method of claim 1, wherein the alteration of the contents of the selected storage device comprises a redundant purge of a portion of the data on the selected storage device.

11. The method of claim 1, wherein the alteration of the contents of the selected storage device comprises an encryption of a portion of the data on the selected storage device.

12. The method of claim 1, wherein the alteration of the contents of the selected storage device comprises a security access lock of a portion of the data on the selected storage device.

13. The method of claim 1, wherein the alteration of the contents of the selected storage device comprises a password lock of a portion of the data on the selected storage device.

14. The method of claim 1, wherein the alteration of the contents of the selected storage device comprises a redundant purge of a portion of the data on the selected storage device.

15. The method of claim 1, wherein the alteration of the contents of the selected storage device comprises an encryption of a firmware on the selected storage device.

16. The method of claim 1, wherein the alteration of the contents of the selected storage device comprises a security access lock of a firmware on the selected storage device.

17. The method of claim 1, wherein the alteration of the contents of the selected storage device comprises the erasure of the data on the selected storage device.

18. The method of claim 1; wherein the alteration of the contents of the selected storage device comprises the purge of a firmware of the selected storage device.

19. A method of altering a storage device, the method comprising:
generating a web page indicating at least one storage device;
displaying the web page indicating the at least one storage device by user a web browser;
selecting a storage device of the at least one storage device by using the web browser;
generating a web page indicating at least one function;
displaying the web page indicating the at least one function by using the web browser;
selecting a function of the at least one function by using the web browser; and
performing the selected function on the selected storage device, wherein performing the selected function comprises altering the data on the selected storage device.

20. A method of altering a storage device, the method comprising:
generating a web page indicating at least one storage device;
displaying the web page indicating the at least one storage device by user a web browser;
selecting a storage device of the at least one storage device by using the web browser;
generating a web page indicating at least one function;
displaying the web page indicating the at least one function by using the web browser;
selecting a function of the at least one function by using the web browser; and
performing the selected function on the selected storage device, wherein performing the selected function alters the data and firmware of the selected storage device.
